(19) United States
(12) Patent Application Publication
(10) Pub. No.: US 2005/0107980 A1
(43) Pub. Date: May 19, 2005

(54) Computerized method and system for measuring an amount of a food ingredient

(76) Inventors: Ugo Cocchis, Richmond (AU); Rainer Sandmann, Arthurs Creek (AU)

Correspondence Address: KNOBBE MARTENS OLSON & BEAR LLP, 2040 MAIN STREET, FOURTEENTH FLOOR, IRVINE, CA, 92614, US

(21) Appl. No.: 10/928,628

(22) Filed: Aug. 26, 2004

Related U.S. Application Data
(63) Continuation of application No. PCT/AU03/00210, filed on Feb. 19, 2003.

(30) Foreign Application Priority Data
Feb. 26, 2002 (AU) 2002100138

(51) Int. Cl. G06F 15/00

(52) U.S. Cl. 702/174

(57) ABSTRACT

Various embodiments are related to a computerized method and system for measuring an amount of a food ingredient. In one embodiment, the computerized method comprises i) transferring a food ingredient into a tank under the control of a microprocessor, ii) measuring the weight of the tank with the use of a load cell, wherein the load cell is in data communication with the microprocessor, iii) generating data indicative of a value of the transferred food ingredient based on the measured weight by the microprocessor, and iv) providing the generated data.

### RELATED APPLICATIONS

This application is a continuation application, and claims the benefit under 35 U.S.C. §§ 120 and 365 of PCT Application No. PCT/AU03/00210, filed on Feb. 19, 2003 and published Sep. 4, 2003, in English, which is hereby incorporated by reference.

### BACKGROUND OF THE INVENTION

1. Field of the Invention

The present invention relates to a computerized method and system for measuring an amount of a food ingredient with the use of a microprocessor.

2. Description of the Related Technology

Flour distribution from Australian flourmills to bakeries is determined by the size or flour consumption of the bakery. Basically there are two methods of distribution employed, the bulk tanker system and the bag system.

The bulk tanker system is used in industrial size bakeries where tanks or silos of 30 to 100 ton capacity are refilled using bulk tankers, which carry a single load of flour from the mill to the bakery. The weight of flour transported is determined by weighing the truck on the mill's weighbridge and the bakery is charged accordingly.

The bag system is used in small to medium sized bakeries, where mostly 25 Kg bags are transported by truck in a palletized form from the mill to a number of smaller bakeries before the truck returns to the mill for reloading.

### SUMMARY OF THE INVENTION

One aspect of the invention reduces manual labor and minimizes potential work injuries which may result from the above bag system.

Another aspect of the invention provides a computerized method of measuring an amount of a food ingredient, comprising delivering flour to a bakery, transferring the flour into a silo, calculating a cost of the delivered flour based on the weight of the silo and issuing a charge.

Preferably, the method further includes monitoring the weight of the silo while the flour exits the silo during production.

Preferably, the method includes delivering flour to a plurality of bakeries and issuing a charge for each bakery based on the weight of the respective silo at each bakery.

Another aspect of the invention provides a computerized system for measuring an amount of a food ingredient, comprising a silo, for receipt of flour, at least one load cell for monitoring the weight of the silo, a microprocessor for monitoring the amount of flour in the silo based on the weight of the silo, and for generating data for use in calculating a charge in respect of the received flour.

Preferably, the microprocessor measures flour exiting the silo for subsequent processing. In one embodiment, the computerized system is located in a bakery.

Still another aspect of the invention provides a computerized method of measuring an amount of a food ingredient, comprising transferring flour from a truck into a silo, measuring the weight of the silo and generating an invoice for the cost of the flour based on the measured weight.

Yet another aspect of the invention provides a computerized method of measuring an amount of a food ingredient, comprising monitoring the weight of a silo at a bakery to determine an amount of flour transferred into the silo, using a microprocessor, wherein the microprocessor generates data for use in calculating a charge in respect of the flour transferred into the silo.

Preferably, the data is transmitted to a remote location for issuing the charge. Preferably, the data is transferred automatically, upon completion of a filling operation.

More preferably, the amount of flour is monitored by weighing the silo as flour is input to and output from the silo.

Preferably, the data includes historical consumption data, which is utilized to determine delivery of further flour.

Preferably, the method further includes delivery of the flour for transferal into the silo.

### BRIEF DESCRIPTION OF THE DRAWINGS

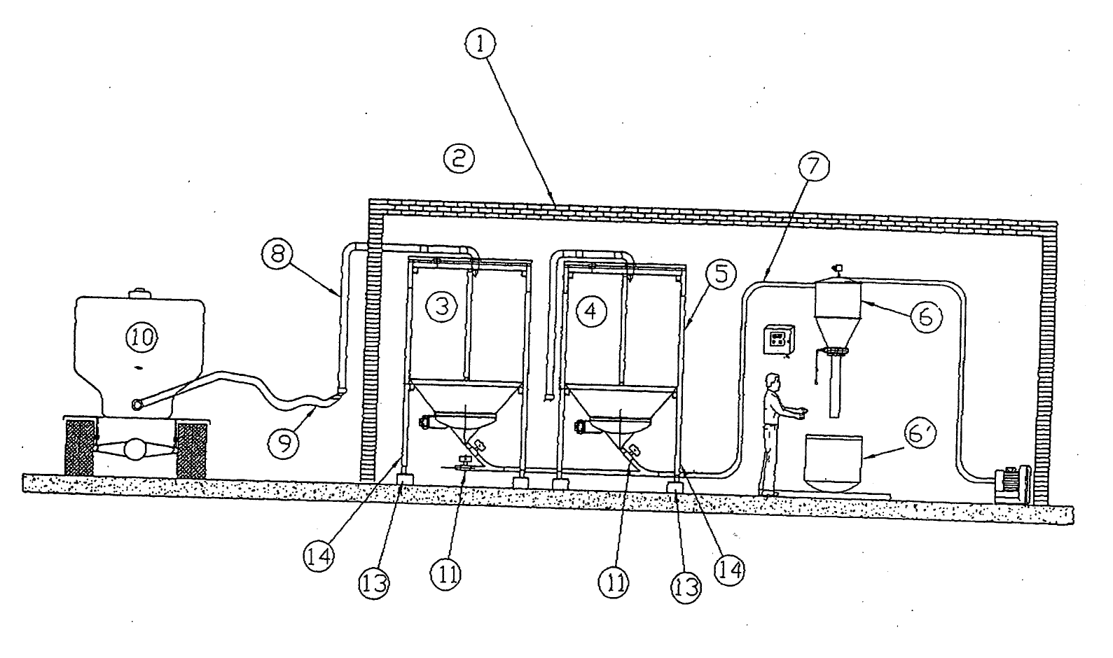

Embodiments of the invention are described in more detail, with reference to FIG. 1, which shows a diagrammatic representation of a computerized system for measuring an amount of a food ingredient with the use of a microprocessor according to one embodiment of the invention.

### DETAILED DESCRIPTION OF CERTAIN INVENTIVE EMBODIMENTS

A facility 1, shown in FIG. 1, includes a system 2. In one embodiment, the system comprises silos 3, 4, supported by a frame 5 and a hopper/mixer 6, 6′ arrangement which receives produce from the silos 3, 4 via line 7. Each silo 3, 4 has a stainless steel inlet pipe 8. The pipe 8 of the left silo 3 is shown connected to a feed pipe 9 of a tanker 10.

In use of the system 2, produce is delivered from the tanker 10, to each of the silos 3, 4, through the connected pipes 8 and 9. When needed, the produce is caused to exit the silos 3, 4 via respective valves 11 at the bottom of each silo 3, 4. From there, the produce is pneumatically transferred to the hopper/mixer 6, 6′ along the line 7, where additional products may be added, if needed. The mixer 6′ dispenses a predetermined quantity of the product for subsequent processing.

The silos 3, 4 are provided with load cells 13, beneath each of the feet 14 of the silo frame 5 for monitoring the weight of the silo 3, 4 and that in turn will provide an indication of the amount of produce not only within each silo, but also being transferred into the silo 3, 4 from the tanker 10 and subsequently exiting the silo 3, 4 for processing. The load cells 13 are preferably linked to a microprocessor (not shown) which may also control the valves 11 and, the entire operation of the system, including the pneumatic transfer of the produce.

Feedback from the load cells 13 is also used to determine the cost of the produce transferred from the tanker 10 and a driver of a truck may carry a portable device, which is adapted to issue a charge in the form of an invoice.

In one embodiment, the produce is in the form of flour and the facility 1 is a bakery. In another embodiment, the produce can comprise other food ingredients.

A more detailed description of the system, when used in a bakery, is as follows:

It is envisaged, for a conventional small sized bakery that a silo in the order of 2.5 to 5 ton capacity would be used. In one embodiment, the silo 3, 4 has a footprint of about 1.8×1.8 meters, which compares favorably with the space requirements of 1.2 m² for a conventional 1 ton pallet of bagged flour.

The flour is delivered pneumatically from the silo 3, 4 to the mixer 6′ via an intermediate hopper 6, which is located next to the dough mixer 6′ and connected with the silo 3, 4 through the pipeline 7, which may be up to 15 meters in length. In order to further reduce cost and dimensional requirements, a smaller structure, which only holds 0.9 to 1.0 ton of flour and measures 1300×1300 mm may be implemented, with an auger system installed in place of the pneumatic system, the pipeline 7 and the intermediate hopper 6.

In one embodiment, both the flour delivery from an external source (e.g., tanker 10) and the flour supply to the dough mixer 6′ are measured or controlled via one microprocessor (not shown).

As may be appreciated, the system 2 can provide a very significant reduction of manual labor in small to medium sized bakeries, as compared to a conventional small bakery where a baker may be lifting on average between 500 Kg and 1000 Kg of bagged flour per day. Using the system 2, this proportion of manual labor is completely removed from the baker's daily routine. The baker can call 1 Kg to 50 Kg of flour from the silo 3, 4 via the hopper 6.

The microprocessor can also allow for storage of frequently used tasks (formulations) and show historical consumption data.

As indicated above, when the flour is delivered to the bakery, the driver can simply connect a portable data processor/printer to the microprocessor. He presses a reset button to zero the weight reading and after the filling of the silo 3, 4 is completed the portable data processor/printer will produce a delivery docket stating the delivered amount of flour and customer details.

The customer retains one hardcopy of the delivery docket and the data contained in the portable data processor will be converted into invoices on return to the mill. In an alternative, the portable data processor may be dispensed with, in which case, the microprocessor generates data for use in calculating a charge in respect of the produce transferred into the silo and transfers that data to a remote location, such as the flour mill, for issuing the charge in the form of an invoice or account statement. The data transfer may be performed using any suitable type of information transfer medium such as electronically, via a conventional modem and telephone line.

The data preferably includes historical consumption data as well, which may be utilized to automatically determine delivery of further flour.

In order to initiate the transfer of data, a system may be devised whereby the driver carries a swipe card, or other form of ID, which is presented to an ID reader at a point of delivery, prior to commencement of a filling operation, so as to automatically reset the measured weight of the silo to zero, ready for receipt of flour. After completion of the filling operation, the card is swiped again and the data is automatically transferred to the remote location/mill.

The ID reader and connection point, where the feed pipe 9 couples to the inlet pipe 8, are preferably arranged externally of the bakery so that the driver can have access to the system 2, to fill the silos 3, 4, without the assistance of staff within the bakery. As such the silos 3, 4 may be filled outside of normal operating hours.

In one embodiment, the system 2 and associated method of delivery reduces the overall cost of a silo system to the point where it is commercially viable for a customer base with a relatively low throughput, which until now would not have been able to be supplied with bulk flour from the tanker 10, or the like.

The overall system also allows the tanker 10 to deliver flour to several bakeries on one truckload and eliminates the necessity for the truck to go back to a weighing bridge after each single delivery for certification of the quantity being delivered for billing purposes.

The following features facilitate some of the main differences of embodiments of the invention compared to an existing bulk supply system:
1) The reduced dimensions and capacity of the silo
2) The use of load cells under the feet of the silo with a double function:
   a. Weighing the flour being delivered by the flourmill
   b. Weighing the flour delivered to the mixer by subtracting from the total weight of the flour present in the silo
3) The microprocessor and its software, which allows not only the control of, the above listed functions, but also a printout of the flour delivered by the tanker.

In contrast, in existing bulk flour storage systems:
the silos are normally too big to fit in small bakeries;
weighing cells are currently only installed under some flour silos and they are only used to double-check the mills flour deposits and are not used to measure the flour pneumatically transported to the dough mixer. Further weighing cells on the weigh hopper are necessary to measure the flour deposit into the mixer;
microprocessors are currently only used to control partial functions of the system, but not to control the functioning of the system in its entirety;
microprocessors are not used to produce a formal document (delivery docket) stating the quantity of flour delivered by the flourmill.

Throughout the specification, the term “silo” has been used for the sake of clarity, however, it is intended that the term include any form of receptacle.

Further, the invention has been described by way of non-limiting example only and many modifications and variations may be made thereto without departing from the spirit and scope of the invention described.

1. A computerized method of measuring an amount of a food ingredient, the method comprising:
transferring a food ingredient from an external delivery source into a tank, located at a food processing facility, under the control of a computing device;
measuring the weight of the tank with the use of a load cell, wherein the load cell is in data communication with the computing device;
generating data indicative of a value of the transferred food ingredient based on the measured weight by the computing device; and
providing the generated data from the computing device to a handheld computing device.

2. The method of claim 1, wherein the food ingredient is flour.

3. The method of claim 1, wherein the computing device is a microprocessor.

4. A computerized method of measuring an amount of a food ingredient, the method comprising:
delivering flour to a bakery;
transferring the flour into a silo;
measuring the weight of the silo with the use of a load cell, wherein the load cell is in data communication with a microprocessor;
generating data indicative of a value of the delivered flour based on the weight of the silo; and
printing the generated data for use by the bakery.

5. The method of claim 4, further comprising:
delivering flour to a plurality of bakeries; and
generating data indicative of a value for each bakery based on the weight of a respective silo at each bakery.

6. The method of claim 4, wherein the transferring is performed under the control of a microprocessor.

7. The method of claim 4, wherein the generating is performed by a microprocessor.

8. A computerized control system for measuring an amount of a food ingredient, the system comprising:
a silo configured to receive flour;
at least one sensor configured to measure the weight of the silo; and
a computing device configured to generate data indicative of a value of the received flour based on the weight of the silo and its contents.

9. The system of claim 8, wherein the computing device is a microprocessor.

10. The system of claim 8, wherein the system is located in a bakery.

11. A computerized method of measuring an amount of a food ingredient, the method comprising:
transferring flour from a truck into a silo;
measuring the weight of the silo with the use of a load cell, wherein the load cell is in data communication with a microprocessor; and
generating data indicative of a value of the transferred flour based on the measured weight.

12. The method of claim 11, wherein the transferring is performed under the control of a microprocessor.

13. The method of claim 11, wherein the generating is performed by a microprocessor.

14. A computerized method of measuring an amount of a food ingredient, the method comprising:
monitoring the weight of a silo at a bakery so as to determine an amount of flour transferred into the silo; and
generating data to be used for calculating a value of the transferred flour based on the monitored weight with the use of a microprocessor.

15. The method of claim 14, wherein the data is transmitted to a remote location for issuing an invoice based on the value.

16. The method of claim 15, wherein the data is transferred to the remote location automatically, upon completion of a filling operation.

17. The method of claim 14, wherein the amount of flour is monitored by weighing the silo as the flour is input to and output from the silo.

18. The method of claim 14, wherein the data includes historical consumption data, which is utilized to determine delivery of further flour

19. The method of claim 14, further comprising delivering the flour for transferal into the silo.

20. The system of claim 8, wherein the at least one sensor is configured to weigh the received flour by subtracting from the total weight of the flour present in the silo.

21. The system of claim 8, wherein the computing device is configured to print the generated data.
